(19) United States
(12) Patent Application Publication
(10) Pub. No.: US 2009/0067993 A1
(43) Pub. Date: Mar. 12, 2009

(54) COATED VARIABLE AREA FAN NOZZLE

(76) Inventors: Gary D. Roberge, Tolland, CT (US); Charles R. Lejambre, New Britain, CT (US); Charles R. Watson, Windsor, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/689,651

(22) Filed: Mar. 22, 2007

(51) Int. Cl. F01D 17/16; F02K 1/06

(52) U.S. Cl. 415/145; 60/771; 415/1

(57) ABSTRACT

A variable area fan nozzle for use with a gas turbine engine system includes a nozzle section that is movable between a plurality of positions to change an effective area associated with a bypass airflow through a fan bypass passage of a gas turbine engine. A protective coating is disposed on the nozzle section and resists change in the effective area of the nozzle section caused by environmental conditions.

### BACKGROUND OF THE INVENTION

This invention relates to gas turbine engines and, more particularly, to a gas turbine engine having a variable fan nozzle that includes a protective coating.

Gas turbine engines are widely known and used for vehicle (e.g., aircraft) propulsion. A typical gas turbine engine includes a compression section, a combustion section, and a turbine section that utilize a core airflow into the engine to propel the vehicle. The gas turbine engine is typically mounted within an outer structure, such as a nacelle. A bypass airflow flows through a passage between the outer structure and the engine, and exits from the engine at an outlet.

Presently, conventional gas turbine engines are designed to operate within a desired performance envelope under certain predetermined flight conditions, such as cruise. Conventional engines tend to approach or exceed the boundaries of the desired performance envelope under flight conditions outside of cruise, such as take-off and landing, which may undesirably lead to less efficient engine operation. For example, the size of the fan and the ratio of the bypass airflow to the core airflow are designed to maintain a desired pressure ratio across the fan during take-off to prevent choking of the bypass flow in the passage. However, during cruise, the bypass flow is reduced in the passage and the fuel burn of the engine is negatively impacted. Since engines operate for extended periods of time at cruise, the take-off design constraint exacerbates the fuel burn impact.

Therefore, there is a need to control the bypass airflow over a wider variety of different flight conditions to enable enhanced control of engine operation and to reduce fuel burn.

### SUMMARY OF THE INVENTION

An example variable area fan nozzle for use with a gas turbine engine system includes a nozzle section that is movable between a plurality of positions to change an effective area associated with a bypass airflow through a fan bypass passage of a gas turbine engine. A protective coating is disposed on the nozzle section and resists change in the effective area of the nozzle section caused by environmental conditions. For example, the protective coating includes material that resists ice formation and erosion of the nozzle section.

In one example, the example variable area fan nozzle having the protective coating is utilized within a gas turbine engine system to resist change in the effective area of the nozzle and thereby provide control over the effective area of the nozzle. For example, the protective coating resists ice formation and erosion that might otherwise artificially change the effective area of the nozzle.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates selected portions of an example gas turbine engine system having a variable area fan nozzle.

FIG. 2 illustrates selected portions of an example nozzle configuration utilizing a protective coating.

FIG. 3 illustrates selected portions of another example nozzle configuration utilizing a protective coating.

### DETAILED DESCRIPTION OF THE PREFERRED EMBODIMENT

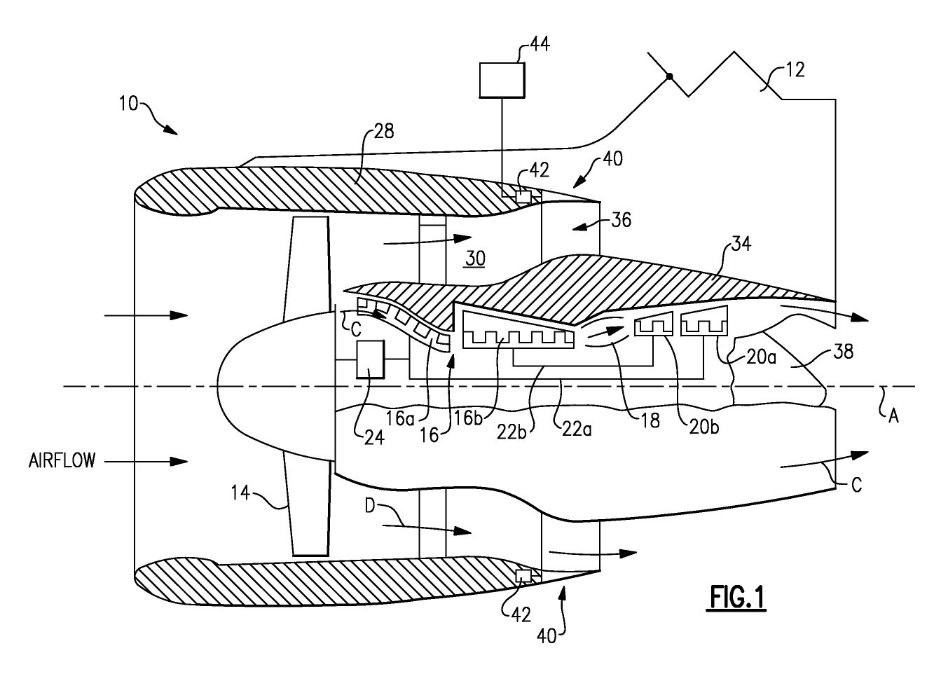

FIG. 1 illustrates a schematic view of selected portions of an example gas turbine engine 10 suspended from an engine pylon 12 of an aircraft, as is typical of an aircraft designed for subsonic operation. The gas turbine engine 10 is circumferentially disposed about an engine centerline, or axial centerline axis A. The gas turbine engine 10 includes a fan 14, a low pressure compressor 16a, a high pressure compressor 16b, a combustion section 18, a high pressure turbine 20b, and a low pressure turbine 20a. As is well known in the art, air compressed in the compressors 16a, 16b is mixed with fuel that is burned in the combustion section 18 and expanded in the turbines 20a and 20b. The turbines 20a and 20b are coupled for rotation with, respectively, rotors 22a and 22b (e.g., spools) to rotationally drive the compressors 16a, 16b and the fan 14 in response to the expansion. In this example, the rotor 22a also drives the fan 14 through a gear train 24.

In the example shown, the gas turbine engine 10 is a high bypass geared turbofan arrangement. In one example, the bypass ratio is greater than 10:1, and the fan 14 diameter is substantially larger than the diameter of the low pressure compressor 16a. The low pressure turbine 20a has a pressure ratio that is greater than 5:1, in one example. The gear train 24 can be any known suitable gear system, such as a planetary gear system with orbiting planet gears, planetary system with non-orbiting planet gears, or other type of gear system. In the disclosed example, the gear train 24 has a constant gear ratio. Given this description, one of ordinary skill in the art will recognize that the above parameters are only exemplary and that other parameters may be used to meet the particular needs of an implementation.

An outer housing, nacelle 28, (also commonly referred to as a fan nacelle) extends circumferentially about the fan 14. A generally annular fan bypass passage 30 extends between the nacelle 28 and an inner housing, inner cowl 34, which generally surrounds the compressors 16a, 16b and turbines 20a, 20b.

In operation, the fan 14 draws air into the gas turbine engine 10 as a core flow, C, and into the bypass passage 30 as a bypass air flow, D. In one example, approximately 80 percent of the airflow entering the nacelle 28 becomes bypass airflow D. A rear exhaust 36 discharges the bypass air flow D from the gas turbine engine 10. The core flow C is discharged from a passage between the inner cowl 34 and a tail cone 38. A significant amount of thrust may be provided by the bypass airflow D due to the high bypass ratio.

The example gas turbine engine 10 shown FIG. 1 also includes a nozzle 40 (shown schematically) associated with the bypass passage 30. In this example, the nozzle 40 is coupled with the trailing edge of the nacelle 28.

The nozzle 40 includes actuators 42 for movement between a plurality of positions to influence the bypass air flow D, such as to manipulate an air pressure of the bypass air flow D. A controller 44 commands the actuators 42 to selectively move the nozzle 40 among the plurality of positions to manipulate the bypass air flow D in a desired manner. The controller 44 may be dedicated to controlling the actuators 42 and nozzle 40, integrated into an existing engine controller within the gas turbine engine 10, or be incorporated with other known aircraft or engine controls. For example, selective movement of the nozzle 40 permits the controller 44 to vary the amount of thrust provided, enhance conditions for aircraft control, enhance conditions for operation of the fan 14, or enhance conditions for operation of other components associated with the bypass passage 30, depending on input parameters into the controller 44.

In one example, the gas turbine engine 10 is designed to operate within a desired performance envelope under certain predetermined conditions, such as cruise. For example, it is desirable to operate the fan 14 under a desired pressure ratio range (i.e., the ratio of air pressure forward of the fan 14 to air pressure aft of the fan 14) to avoid fan flutter. To maintain this range, the nozzle 40 influences the bypass airflow D to control the air pressure aft of the fan 14 and thereby control the pressure ratio. For example, for a cruise condition, the nozzle 40 permits less bypass airflow D, and in a take-off condition the nozzle permits more bypass airflow D. In some examples, the nozzle varies a cross-sectional area associated with the bypass passage 30 by approximately 20% to increase the bypass airflow D for take-off. Thus, the nozzle 40 enables the performance envelope to be maintained over a variety of different flight conditions.

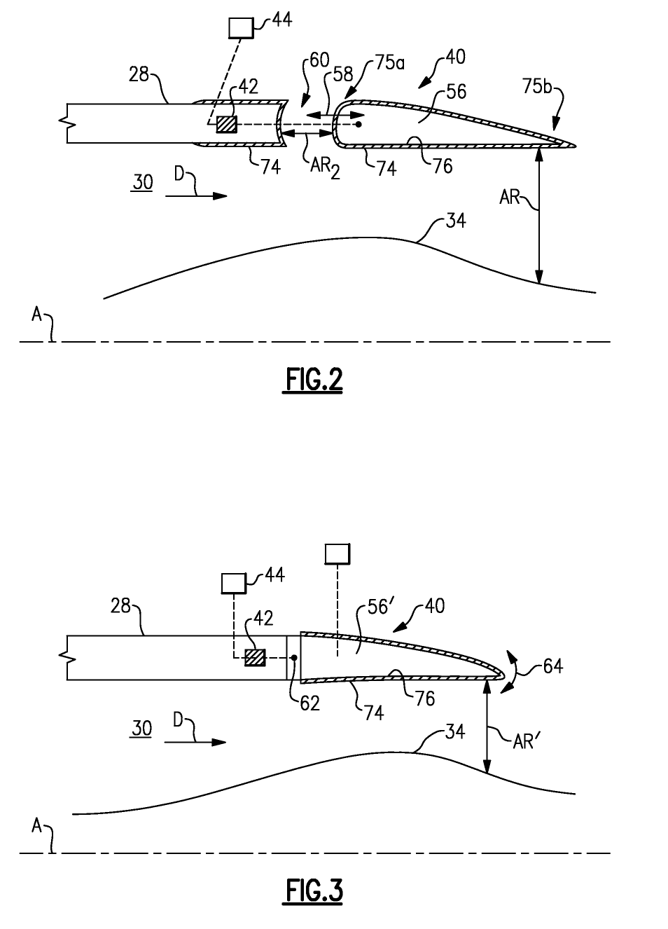

FIG. 2 illustrates selected portions of an example nozzle 40 having a nozzle section 56 that is movable in a generally axial direction 58 between a plurality of different positions to influence the bypass airflow D by changing an effective flow area (e.g., a cross-sectional area) of the nozzle 40. In this example, the nozzle section 56 is operatively connected with the actuator 42 for movement in the axial direction 58. The controller 44 selectively commands the actuator 42 to move the nozzle section 56 to open or close an auxiliary flow path 60 between the nozzle section 56 and the nacelle 28. The effective flow area of the nozzle 40 is the sum of the cross-sectional area between the nozzle section 56 and the inner cowl 34 represented by the distance AR and a cross-sectional area of the auxiliary flow path 60 represented by AR₂.

In an open position, as illustrated, the auxiliary flow path 60 permits at least a portion of the bypass airflow D to exit axially through the nozzle 40 and also radially through the auxiliary flow path 60. In a closed position, the nozzle section 56 abuts against the nacelle 28 such that the bypass airflow D exits only axially. The controller 44 and the actuator 42 cooperate to change the effective flow area of the nozzle 40 by selectively opening or closing the nozzle section 56, depending on flight conditions of an aircraft.

For example, moving the nozzle section 56 to the open position for a relatively larger total flow area permits more bypass airflow D through the nozzle 40 and reduces a pressure build-up (i.e., a decrease in air pressure) within the bypass passage 30. Moving the nozzle section 56 to the closed position for a relatively smaller total flow area restricts the bypass airflow D and produces a pressure build-up (i.e., an increase in air pressure) within the bypass passage 30. Thus, the controller 44 can selectively control the air pressure within the bypass passage 30 to thereby control the pressure ratio across the fan 14 as described above. For example, during take-off, the nozzle section 56 is open to achieve a desired pressure ratio that permits the fan 14 to avoid a flutter condition, prevent choking, and thereby operate more efficiently.

FIG. 3 illustrates selected portions of another example nozzle 40 wherein the nozzle section 56′ pivots about a pivot connection 62 along direction 64. In this example, the controller 44 selectively commands the actuator 42 to pivot the nozzle section 56′ to selectively vary the flow area represented by AR′, which in this example represents the total effective flow area. As can be appreciated from FIG. 3, pivoting the nozzle section 56′ toward the centerline axis A decreases the flow area AR′, and pivoting the nozzle section 56′ away from the centerline axis A increases the flow area AR′. As described above, a relatively smaller total flow area restricts the bypass airflow D, and a relatively greater total flow area permits more bypass airflow D through the nozzle 40. It is to be understood that the above example nozzles 40 are not limiting and that other types of variable area nozzles will also benefit from this disclosure.

In the illustrated examples, the nozzle section 56, 56′ includes a protective coating 74 that resists changes in the effective flow area of the nozzle 40 from environmental conditions. In FIG. 2, the protective coating 74 completely encases the underlying nozzle section 56 from a leading end 75a to a trailing end 75b. Alternatively, the protective coating 74 may be located only on particular areas (e.g., only on the leading end 74a) of the nozzle section 56, depending upon the areas that are expected to be susceptible to ice formation and erosion, for example. In FIG. 3, the protective coating covers only an inner and outer surface of the nozzle section 56′. Alternatively, the protective coating is only on the inner surface.

Optionally, a portion of the nacelle 28 also includes the protective coating 74. For example, the protective coating 74 covers a trailing end portion of the nacelle 28 (FIG. 2) and covers the inner and outer surfaces of the nacelle 28, and an axial surface 75 between the nacelle 28 and the nozzle section 56.

The protective coating 74 resists formation of ice, erosion, or both. Protecting against, and in some cases entirely preventing, ice formation and erosion provides the benefit of maintaining aerodynamically smooth surfaces over the nozzle section 56, 56′ and/or nacelle 28, and preventing the effective flow area from artificially and undesirably changing due to ice formation or erosion. The protective coating 74 may also prevent ice from accreting to a size that is large enough to hinder the movement of the nozzle section 56, 56′.

In one example, the protective coating 74 comprises an icephobic material having an ice adhesion strength that is less than an ice adhesion strength of the underlying nozzle section 56, 56′. Additionally, the protective coating 74 may be erosion resistant such that an erosion resistance of the protective coating 74 is greater than an erosion resistance of the underlying nozzle section 56, 56′. For example, the underlying nozzle section 56, 56′ may include titanium, aluminum, metallic alloys, or polymer composite. Icephobic characteristics and erosion resistance characteristics may be embodied in a single type of protective coating 74, or the protective coating 74 may utilize a material that is suited for either icephobicity or erosion resistance alone.

In one example, the protective coating 74 includes a material selected from a silicone-based elastomer, a polyurethane-based elastomer, and a fluoropolymer. In a further example, the silicone-based elastomer comprises a high molecular weight polysiloxane, such as platinum cured vinyl terminated polydimethyl siloxane, peroxide cured vinyl terminated polydimethyl siloxane, polyphenylmethyl siloxane, 4-polytrifluoropropylmethyl siloxane, or polydiphenyl siloxane. In a further example, the above materials are used without solid fillers, liquid fillers, or additives to further enhance the icephobic and erosion characteristics of the protective coating 74. In a further example, the protective coating 74 has an ice adhesion strength of no more than about 388 kpa, and in some examples, no more than about 200 kpa. Although the above example materials may be effective for protecting the nozzle sections 56, 56′, in one example the silicone-based elastomers provide the benefit of icephobicity and erosion resistance because of the lack of fillers and additives. Given this description, one of ordinary skill in the art will recognize other types of icephobic and erosion resistant materials to meet their particular needs.

Optionally, a primer layer 76 may be used between a protective coating 74 and the nozzle section 56, 56′ for adhesion. For example, the primer layer 76 includes a silane or titanate coupling agent with or without a catalyst such as platinum, palladium, rhodium. The primer layer 76 and the protective coating 74 may be applied on the nozzle sections 56, 56′ using known techniques, such as spray, electrostatic deposition, brushing, dipping, or the like, and cured as needed using known techniques.

The disclosed examples thereby provide a nozzle 40 having a nozzle section 56, 56′ with the protective coating 74 to resist undesirable variation in the effective flow area from environmental conditions. For example, the protective coating 74 reduces ice formation by entirely preventing ice from adhering to the nozzle 40 or by reducing a rate at which the ice accretes on the nozzle 40. Thus, when the controller 44 moves the nozzle section 56 to a position that is pre-calculated to correspond to an effective flow area, ice formation does not artificially decrease the effective flow area and erosion does not artificially increase the effective flow area from the expected, pre-calculated effective flow area. Thus, using the protective coating 74 on the nozzle section 56, 56′ provides the benefit of reliably controlling the nozzle 40 and effective flow area without undue environmental interference.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A variable area fan nozzle for use with a gas turbine engine system, comprising:
a nozzle section that is moveable between a plurality of positions to change an effective area associated with a bypass airflow through a fan bypass passage of a gas turbine engine; and
a protective coating on the nozzle section that resists change in the effective area of the nozzle section caused by environmental conditions.

2. The variable area fan nozzle as recited in claim 1, wherein the protective coating comprises an anti-icing coating having an ice adhesion strength that is less than an ice adhesion strength of the nozzle section.

3. The variable area fan nozzle as recited in claim 1, wherein the protective coating comprises an anti-erosion coating having an erosion resistance that is greater than an erosion resistance of the nozzle section.

4. The variable area fan nozzle as recited in claim 3, wherein nozzle section includes an outermost surface that comprises a polymer composite material.

5. The variable area fan nozzle as recited in claim 1, wherein the protective coating comprises a silicone-based elastomer.

6. The variable area fan nozzle as recited in claim 1, wherein the protective coating comprises polysiloxane.

7. The variable area fan nozzle as recited in claim 1, wherein the protective coating comprises at least one of a polyurethane-based elastomer and a fluoropolymer.

8. The variable area fan nozzle as recited in claim 1, wherein the protective coating comprises a high molecular weight polysiloxane selected from at least one of platinum cured vinyl terminated polydimethyl siloxane, peroxide cured vinyl terminated polydimethyl siloxane, polyphenylmethyl siloxane, 4-polytrifluoropropylmethyl siloxane, and polydiphenyl siloxane.

9. The variable area fan nozzle as recited in claim 1, wherein the protective coating is located on a leading edge of the nozzle section.

10. The variable area fan nozzle as recited in claim 1, further comprising an anti-icing device that is operational to melt or break any ice that forms on the protective coating.

11. A gas turbine engine system comprising:
a fan;
a structure arranged about the fan;
an engine core having a compressor and a turbine at least partially within the structure;
a fan bypass passage between the structure and the gas turbine engine;
a nozzle section that is moveable between a plurality of positions to change an effective area associated with a bypass airflow through the fan bypass passage; and
a protective coating on the nozzle section that resists change in the effective area of the nozzle section caused by environmental conditions.

12. The gas turbine engine system as recited in claim 11, wherein the protective coating is located between the nozzle section and the structure.

13. The gas turbine engine system as recited in claim 11, wherein the protective coating is located between the nozzle section and an inner cowl that corresponds to the engine core.

14. The gas turbine engine system as recited in claim 11, wherein the protective coating is also on at least a portion of the structure arranged about the fan.

15. The gas turbine engine system as recited in claim 14, wherein the protective coating is on a trailing edge of the structure arranged about the fan.

16. The gas turbine engine system as recited in claim 11, a controller for selectively moving the nozzle section responsive to one of a plurality of operational states of the gas turbine engine.

17. A method of controlling an effective area associated with a variable nozzle section of a gas turbine engine, the method comprising:
applying a protective coating on the variable nozzle section to resist a change in an effective area of the nozzle section from environmental conditions.

18. The method as recited in claim 17, further including selecting the protective coating to have an ice adhesion strength that is less than an ice adhesion strength of the variable nozzle section.

19. The method as recited in claim 17, further including selecting the protective coating to have an erosion resistance that is greater than an erosion resistance of the variable nozzle section.
